(19) United States
(12) Patent Application Publication
(10) Pub. No.: US 2010/0017599 A1
(43) Pub. Date: Jan. 21, 2010

(54) SECURE DIGITAL CONTENT MANAGEMENT USING MUTATING IDENTIFIERS

(75) Inventors: William R. Sellars, Milwaukee, WI (US); Richard Malina, Mequon, WI (US); William Cochran, Champaign, IL (US)

Correspondence Address: MICHAEL BEST & FRIEDRICH LLP, 100 E WISCONSIN AVENUE, Suite 3300, MILWAUKEE, WI, 53202, US

(73) Assignee: IMAGINEER SOFTWARE, INC., Milwaukee, WI (US)

(21) Appl. No.: 12/296,146

(22) PCT Filed: Feb. 8, 2007
(86) PCT No.: PCT/US07/03440

§ 371 Date: Sep. 21, 2009

Related U.S. Application Data
(60) Provisional application No. 60/771,398, filed on Feb. 8, 2006.
(60) Provisional application No. 60/771,366, filed on Feb. 8, 2006.

(51) Int. Cl. H04L 9/12

(52) U.S. Cl. 713/156

(57) ABSTRACT

Methods and system for managing manipulation of digital content stored in a content server. One method includes receiving a first mutating identifier at a content manipulation device. The first mutating identifier includes a first secret key. The method also includes generating a content request for digital content stored in the content server at the content manipulation device, the content request encrypted with the first secret key and including an identifier of the digital content; transmitting the content request to an authenticator over at least one communication link; transmitting access rights from the authenticator to the content manipulation device over at least one communication link; transmitting the digital content from the content server to the content manipulation device; manipulating the digital content at the content manipulation device based on the access rights; and marking the first mutating identifier as used at the authenticator.

### RELATED APPLICATIONS

The present application claims priority to U.S. Provisional Application Nos. 60/771,366 and 60/771,398, both filed on Feb. 8, 2006, the entire contents of which are both herein incorporated by reference. The present application is also a continuation-in-part of U.S. application Ser. No. 11/368,959, filed on Mar. 6, 2006, which is a continuation-in-part of U.S. application Ser. No. 11/286,890, filed on Nov. 23, 2005, which is a continuation-in-part of U.S. application Ser. No. 10/854,604, filed on May 26, 2004, which is a continuation-in-part of U.S. application Ser. No. 10/248,894, filed on Feb. 27, 2003, which claims priority to U.S. Provisional Application No. 60/360,023, filed on Feb. 27, 2002, the entire contents of which are all herein incorporated by reference.

### BACKGROUND OF THE INVENTION

An intranet includes a network established for use by a particular group of individuals. For example, an organization, such as a business, may establish an intranet in order to connect multiple devices (e.g., computers, printers, routers, servers, etc.) managed by the organization, and a member of the organization logging on or connecting to the intranet can then access some or all of the devices managed by the organization.

Intranet operators may want to limit access to specific devices and specific data and/or software provided by devices for particular authorized users of an intranet. For example, a particular authorized user of an intranet may only be allowed to access particular data or files stored in a server connected to the intranet. In addition, intranet operators may want to authenticate devices and/or users of devices before allowing a device to connect to the intranet or a device connected thereto.

In addition, intranet operators may want to limit and secure the distribution and the manipulation of specific data accessed by authorized users of the intranet. For example, intranet operators may want to prevent a specific individual from modifying data, copying data, saving a copy of the data to disk or an unauthorized storage device, sending a copy to an unauthorized user, etc.

### SUMMARY OF THE INVENTION

Embodiments of the invention provide methods and systems for securely transmitting data and providing software over an intranet using mutating IDs. Another embodiment provides methods and systems for authorizing communication between devices connected to an intranet using mutating IDs. Additional embodiments provide methods and systems for authenticating devices connecting to an intranet and/or connecting to devices connected to an intranet using mutating IDs. Furthermore, embodiments provide methods and systems for providing secure digital content management using mutating IDs.

Some embodiments of the invention provide methods for managing manipulation of digital content stored in a content server. One method includes receiving a first mutating identifier at a content manipulation device, the first mutating identifier including a first secret key, and generating a content request for digital content stored in the content server at the content manipulation device. The content request is encrypted with the first secret key and includes an identifier of the digital content. The method also includes transmitting the content request to an authenticator over at least one communication link; transmitting access rights from the authenticator to the content manipulation device over at least one communication link; transmitting the digital content from the content server to the content manipulation device; manipulating the digital content at the content manipulation device based on the access rights; and marking the first mutating identifier as used at the authenticator.

Additional embodiments of the invention provide systems for managing manipulation of digital content stored in a content server. One system includes an authenticator and a content manipulation device. The authenticator is configured to assign a first mutating identifier to the content manipulation device and the content manipulation device is configured to generate a content request for digital content stored in the content server. The first mutating identifier includes a first number or label and a first secret key. The content request is encrypted with the first secret key and includes an identifier of the digital content. The content manipulation device transmits the content request to the authenticator over at least one communication link and receives a package from the authenticator encrypted with the first secret key and includes access rights. The content management device also receives the digital content from the content server over at least one communication link and manipulates the digital content based on the access rights. The access rights are associated with the content manipulation device and the digital content. The authenticator also marks the first mutating identifier as used.

Further embodiments of the invention provide computer-readable medium encoded with a plurality of processor-executable instructions for manipulating digital content. The medium includes an instruction for generating a content request for digital content stored in a content server, where the content request is encrypted with a first secret key of a first mutating identifier and includes an identifier of the digital content and identifying information of a user. The medium also includes instructions for receiving the digital content from the content server; receiving a package from an authenticator, the package encrypted with the first secret key and including access rights; and manipulating the digital content based on the access rights.

In addition, some embodiments of the invention provide an authenticator for managing manipulation of digital content stored in a content server. One authenticator includes a memory module configured to store a first mutating identifier assigned to content manipulation device. The first mutating identifier includes a first secret key. The authenticator also has an input/output module configured to receive a content request for digital content from the content manipulation device over at least one communication link, and a processor configured to generate a package for the content manipulation device based on the content request. The content request and package are encrypted with the first secret key. The package includes access rights specifying permitted manipulation of the digital content. The input/output module is configured to transmit the package to the content manipulation device over at least one communication device.

### BRIEF DESCRIPTION OF THE DRAWINGS

In the drawings:

FIG. 1 schematically illustrates a system for transmitting data within an intranet according to one embodiment of the invention.

FIG. 2 illustrates a bit stream (called a “mutating ID”) according to one embodiment of the invention.

FIGS. 3A and 3B illustrate ways of distributing mutating IDs.

FIGS. 4 and 5 schematically illustrate a system for managing digital content manipulation using mutating IDs according to one embodiment of the invention.

FIG. 6 illustrates a protocol for managing storing digital content within the system of FIGS. 4 and 5 using mutating IDs according to one embodiment of the invention.

FIG. 7 illustrates a protocol for managing accessing digital content within the system of FIGS. 4 and 5 using mutating IDs according to one embodiment of the invention.

FIG. 8 schematically illustrates a system for managing rights associated with digital content manipulation according to one embodiment of the invention.

### DETAILED DESCRIPTION

Before embodiments of the invention are explained in detail, it is to be understood that the invention is not limited in its application to the details of the construction and the arrangements of the components set forth in the following description or illustrated in the drawings. The invention is capable of still other embodiments and of being practiced or being carried out in various ways.

In particular, it should be understood that some embodiments are implemented using various computer devices, such as personal or home computers, servers, and other devices that have processors or that are capable of executing programs or sets of instructions, including special-purpose devices, such as set top boxes (e.g., digital cable or satellite decoders). In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and output mechanisms. In some cases, the devices may also have one or more operating systems and one or more application programs that are managed by the operating systems. In some embodiments, the hardware devices or software executed by the hardware devices also provides some ability, depending on the role of the device in the particular embodiment of the invention implemented, to compress or decompress data or to encode data or decode encrypted data. In some instances, a decompression capability may be provided using available codecs, such as hardware-implemented Moving Picture Experts Group (“MPEG”) codecs. A decryption capability may be provided using a decryption hardware or software module capable of decrypting data that is encrypted using a particular encryption algorithm. In some embodiments, the encryption algorithm includes the Rijndael algorithm, an example of which is available at http://www.esat.kuleuven.ac.be/˜rijmen/rijndael/rijndaelref.zip.

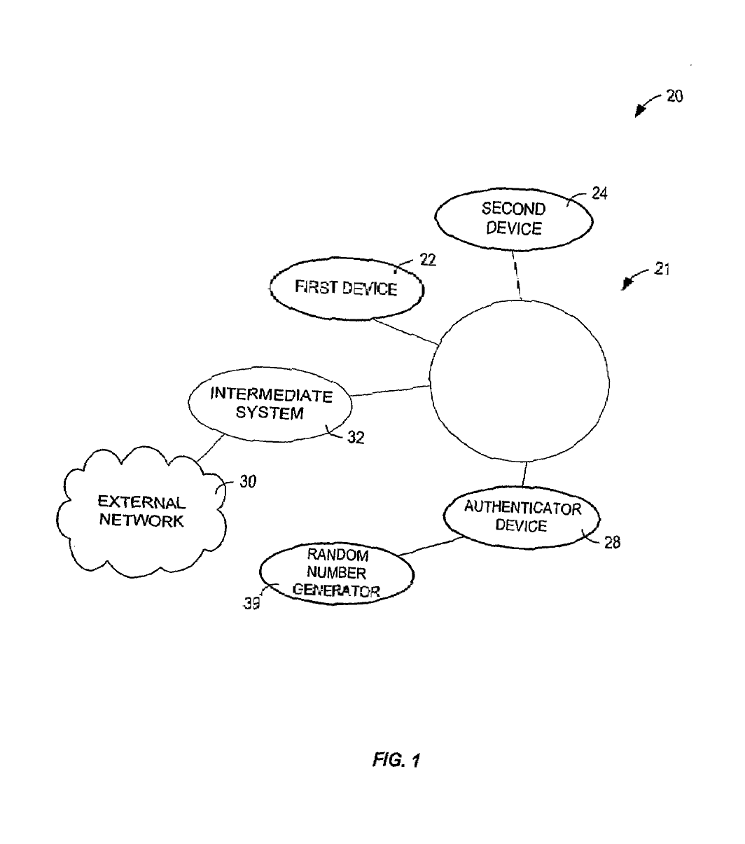

FIG. 1 illustrates an exemplary system 20 configured to distribute data and software within an intranet 21. The intranet 21 operates internally within an organization, such as a company or the like. Therefore, the intranet 21 is not, in general, accessible to outsiders (e.g., persons or entities that are not affiliated with the organization). The intranet 21 may, however, provide access to an external network 30, such as the Internet, via a router, a bridge, or another intermediate system 32. The intranet 21 includes one or more types of network connections and transmission mediums, such as a telephone or twisted pair network, a wireless network, a satellite network, a cable TV network, an Ethernet-based network, an optical fiber network, and/or various other networks as would be apparent to one of ordinary skill in the art. Thus, the invention is not limited to any specific network or combinations of networks. However, in some embodiments, the networks or communication systems used in the system 20 have the ability to support digital and/or secure communications, such as communications involving data encrypted with a version of Rijndael encryption, secured socket layer (“SSL”) communications, digital signature standard (“DSS”) communications, or other types of secure communication protocols. Further, data can be transferred from one entity to another with wired communications and/or wireless communications or media being physically carried from one entity to another.

In the embodiment shown in FIG. 1, three participants are connected to the intranet 21: a first device 22, a second device 24, and an authenticator device or authenticator 28. The first device 22, the second device 24, and the authenticator 28 are operated by the organization operating the intranet 21. Although the participants are shown in FIG. 1 attached to the intranet 21 in a ring topology, other network topologies and layouts could be used as would be apparent to one of ordinary skill in the art.

In the exemplary embodiment illustrated in FIG. 1, it is assumed that the first device 22 possesses data (e.g., a file) and/or software (e.g., an application or program) to be transmitted to or provided for the second device 24. Although FIG. 1 only illustrates the first device 22 and the second device 24, in most embodiments, numerous devices are included in the system 20, wherein at least one of the devices possesses data and/or software to be transmitted to or executed for another device. Furthermore, in some embodiments, the system 20 includes multiple authenticators 28.

In some embodiments, as shown in FIG. 1, the authenticator 28 uses a random number generator 39 to generate numbers used by a protocol implemented or followed by the system 20. The random number generator 39 produces numbers that are truly random (i.e., numbers that are as random as is possible with the particular technology used to implement the invention). For example, communication traffic, such as requests from customers to obtain content, can be used to create random numbers. Such requests occur, in general, in an unpredictable manner. Thus, the random numbers generated based on such traffic are also truly or nearly truly random, as opposed to pseudo random numbers generated with algorithmic methods.

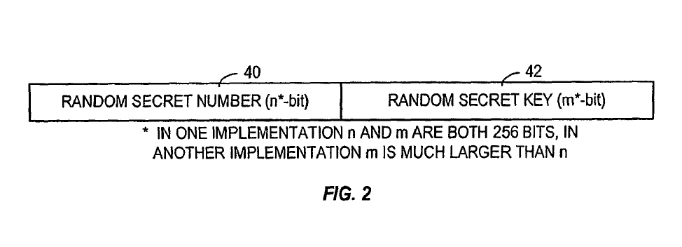

In some embodiments, the first device 22 and the second device 24 use mutating identifiers (“IDs”) to obtain data and/or software from a device connected to the intranet 21. An exemplary mutating ID 38 is shown in FIG. 2. The mutating ID 38 is an identifier having two portions: a first portion 40 and a second portion 42. The first portion 40 includes an identifying number, which is a random number. As indicated in FIG. 2, in some embodiments, the two portions of a mutating ID each include a predetermined number of bits. For example, the first portion 40 and the second portion 42 can each include 256 bits. In other embodiments, the first portion 40 and/or the second portion 42 include a larger number of bits, such as 1 megabit or 1 megabyte.

The second portion 42 of the mutating ID 38 includes a secret key, which is also a random number and, in some embodiments, is a symmetric cipher key. A mutating ID is used only once and then cannot be used again.

In addition, although FIG. 2 illustrates a mutating ID as having only two portions, a mutating ID can include additional sections or portions. For example, a mutating ID can include an identifying number, a secret key for a first type of data (e.g., discoverable data), and a secret key for a second type of data (e.g., undiscoverable data).

Mutating IDs are generated and tracked by the authenticator 28. Because mutating IDs are one-time-use mechanisms, once the first device 22, the second device 24, or another device uses its supply of mutating IDs (e.g., a single mutating ID or multiple mutating IDs), the device obtains another mutating ID (or multiple mutating IDs, if applicable) from the authenticator 28. The data included in a mutating ID assigned to a particular device can be chosen at random with an equal probability of all possible mutating IDs.

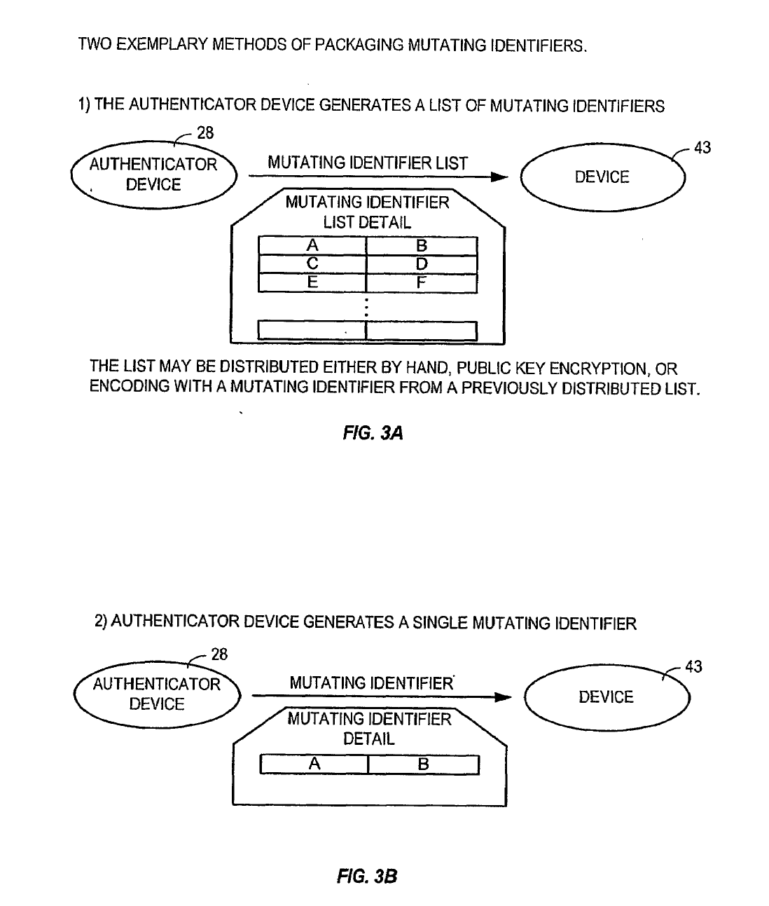

FIGS. 3a and 3b illustrate how mutating IDs are distributed from the authenticator 28 to the first device 22 or the second device 24. As shown in FIG. 3a, in some embodiments, a device 43, such as the first device 22 or the second device 24, requests multiple mutating IDs from the authenticator 28. The authenticator 28 creates as many mutating IDs as the device 43 requested and sends a list of mutating IDs to the device 43. The device 43, knowing the quantity of mutating IDs requested and the size of each mutating ID, breaks the list into individual mutating IDs. In some embodiments, the authenticator 28 provides information or instructions to the device 43 to assist the device 43 in separating the list of mutating IDs into individual mutating IDs. For example, the authenticator 28 can provide information or instructions to the device 43 to assist the device 43 in separating the list of mutating IDs using a data description language, such as extensible markup language (“XML”).

As shown in FIG. 3b, in other embodiments, a device 43 receives a single mutating ID from the authenticator 28. The device 43 receives the single mutating ID upon requesting a mutating ID from the authenticator 28 or can automatically receive a new mutating ID from the authenticator 28 upon using a previously provided mutating ID. The mutating ID is sent to the device 43 and replaces the mutating ID previously provided or assigned to the device 43.

In the embodiment shown in FIG. 1, the authenticator 28 randomly assigns or provides a mutating ID to the first device 22 (hereinafter referred to in this example as the “first mutating ID”) and a mutating ID to the second device 24 (hereinafter referred to in this example as the “second mutating ID”). The first mutating ID is different from the second mutating ID and each of the first mutating ID and the second mutating ID do not provide information for determining the other mutating ID. As described above with respect to FIG. 2, each mutating ID includes a random number 40 and a corresponding random secret key 42. In some embodiments, a mutating ID takes the form of a modified hash. As described above, in addition to being random, the mutating ID (or the hash if applicable) is discarded after each use. In other words, the authenticator 28 provides a new mutating ID with a new random number 40 and a new random secret key 42 to a device after the device uses a mutating ID. In some embodiments, the mutating ID is completely unrelated from the device using it. That is, the mutating ID or the hash does not contain any information concerning the identity of the device receiving and using the mutating ID. In this way, except for the authenticator 28, individual devices are blind to the identities of other devices included in the system.

In some embodiments, a device uses an assigned mutating ID to encrypt messages and/or data to be transmitted through the intranet 21. For example, some embodiments of the invention implement symmetric key systems for encrypting messages and/or data. Symmetric key systems commonly encounter key management issues as the number of entities or parties of the system grows. For example, a network of n entities requires n(n−1)/2 keys to enable all entities to communicate with one another. Thus, for a system of 1000 entities, where every entity wishes to send identical content to every other entity, almost a half million keys are required.

Disclosed embodiments, however, do not require a separate key for every pair of entities of the system. As will be illustrated, each entity and each piece of content distributed by each entity receives one key, which is mutated after each use. Therefore, for a system of 1000 entities, only 2000 keys are required compared to the almost half of a million keys with previous symmetric key systems. Also, the authenticator 28 is not required to store the entire bit string of a mutating ID. The authenticator 28 may use a hash function or simply a positional index to map each key partition of a mutating ID into a memory storage location based on the corresponding number of the mutating ID.

Other differences between embodiments of the invention and prior security systems relate to speed and reduced vulnerability to certain attacks. For example, the use of symmetric keys allows fast computation (as compared to public key systems). The fundamental concept behind public key systems is the use of one-way functions. One-way functions are easy to compute but hard to reverse. Public key systems use trapdoor one-way functions that provide a key to compute the one-way function in the opposite direction. Systems employing public key systems provide a public key and a private key for each participant. The public keys are accessible by all participants and the associated private keys are known only by the participant associated with the private key. Participants use the public keys to encrypt messages for a particular participant or to decrypt messages received from the particular participant using a one-way function. Participants use their confidential private key (which are believed to be computationally infeasible to derive from the public key) to encrypt messages for other participants (which the other participants can decrypt using the associated public key for the participant) or to decrypt messages received from other participants (which were encrypted with the associated public key for the participant).

The security of public key systems relies on the assumption that the private key cannot be derived from the public key. In order to maintain this requirement, the one-way functions used in public key systems are complex. The added complexity, however, comes at the cost of added computation time. Public key systems are often 1000 times slower than symmetric key systems.

The use of symmetric keys also reduces the effectiveness of chosen plaintext attacks. A chosen-plaintext attack occurs when an intruder has access to an encryption key or process, chooses specific plaintext to encrypt, and attempts to gain knowledge from the encrypted text. In public-key systems an individual's public key is known to all participants in a communication system. Any intruder can encrypt an endless number of messages using an individual's public key. If an attacker encrypts possible messages with an individual's public key and then intercepts an encrypted message sent to the individual, the intruder compares the intercepted message with messages he or she has created. If an intercepted message matches an encrypted message created by the intruder, the message has been compromised and the intruder can now read a message that was not intended for him or her. This attack is relatively easy and effective if a small number of possible messages exist, but even if the number of possible messages is more than the intruder is able to encrypt or compare with intercepted encrypted messages, just knowing that an intercepted encrypted message does not correspond to a particular message can provide useful information to the intruder. In both situations, the intruder will not be able to deduce the private key of the individual, but the intruder may be able to deduce the message, or information regarding the message, sent to the individual. Since embodiments of the invention utilize a symmetric key system, chosen-plaintext attacks are not applicable because encryption keys are not public knowledge.

There is another problem with prior symmetric key systems and public key systems. Once an unauthorized entity gains access to a key, the unauthorized entity can decode all messages encrypted with the key, and, perhaps more dangerous, can encrypt false messages with the key in order to deceive other entities of the system. The mutating ID protocol reduces this weakness by mutating each secret key after it has been used. Even if a key is compromised, the compromised key cannot be used to generate future messages nor can it be used to decrypt future messages since it is marked by the authenticator 28 as “used” and, therefore, cannot and will not be used for future messages.

A device can also use an assigned mutating ID to provide credentials (e.g., previously assigned by the authenticator 28) to the authenticator 28 in order to authenticate itself with the authenticator 28. Since the authenticator 28 assigns the mutating IDs and the credentials to the devices included in the system 20, the authenticator 28 can verify that the credentials are valid and that they match a mutating ID provided by a device (e.g., a mutating ID and credentials provided by a device are assigned to the same device). If the credentials are valid, the authenticator 28 allows the device providing the credentials (i.e., the “requesting device”) access to particular data and/or software accessible through the intranet 21. In one embodiment, the authenticator 28 provides the requesting device with a session key for communicating with another device connected to the intranet 21, a decryption key for decrypting data obtained from another device connected to the intranet 21, or a password or other access mechanism for connecting to another device connected to the intranet 21, particular data and/or a particular application, etc. Upon validating the credentials of the requesting device, the authenticator 28 may also forward a particular request or message to another device connected to the intranet 21 on behalf of the requesting device.

In addition, if the credentials received from the requesting device are valid, the authenticator 28 uses the credentials (and, consequently, the identity of the associated requesting device) to determine whether the requesting device is allowed to perform certain functions. For example, if the authenticator 28 determines that credentials provided by the requesting device are valid but that the requesting device is not authorized to access the particular data and/or software requested by the requesting device, the authenticator 28 can deny the device's request.

The system 20 uses a protocol to govern communications between entities. Each entity is randomly assigned a mutating ID, such as the identifier or ID 38 shown in FIG. 2, by the authenticator 28. As noted, each mutating ID includes a random number 40 and a random corresponding secret key 42. In some embodiments, a mutating ID takes the form of a modified hash.

In some embodiments, the authenticator 28 also generates encryption keys for content or data distributed through the system 20. To request an encryption key, a device wanting to send data (i.e., the “sending device”) supplies the authenticator 28 with the data it wants to transmit or a label or function (i.e., any identifying string) of the data it wants to transmit, and the authenticator 28 responds with an associated encryption key. The encryption key, like the mutating IDs, can be unrelated to the data that it encrypts. In addition, if the sending device only sends an identifier to the authenticator 28 (e.g., a random identifier) of the data it wants to transmit, the authenticator 28 has no knowledge of the data associated with a particular encryption key. The authenticator 28 records the assigned key and the associated data or identifier of the data.

In addition to or as an alternative to requesting an encryption key, the sending device can send credentials to the authenticator 28. The authenticator 28 validates the credentials, determines the identity of the sending device providing the credentials, and can reject or accept the request based on whether the credentials are valid and whether the sending device is authorized to transmit the data. The sending device also supplies the authenticator 28 with an identity of the intended recipient of the data, and the authenticator 28 determines whether the sending device is authorized to transmit the data to the intended recipient.

After the authenticator 28 generates and supplies an encryption key to the sending device, the sending device uses the encryption key to encrypt the data. The sending device then sends the encrypted data to a device. To decrypt the encrypted data, the device receiving the encrypted data (i.e., the “receiving device”) requests the corresponding decryption key (e.g., the same key used to encrypt the data) from the authenticator 28. In some embodiments, the authenticator 28 supplies a decryption key to any device included in the system 20 that makes a legitimate request. A request for a decryption key can include a reference to the data (e.g., the label or identifying string of the data) that the receiving device wants to decrypt.

In some embodiments, the request also includes credentials of the receiving device. The authenticator 28 validates the credentials of the receiving device and determines the associated key based on the label indicated in the request and returns the appropriate key to the receiving device. The authenticator 28 also determines an identity of the receiving device and determines whether the receiving device is authorized to receive the key to decrypt the data. If the credentials of the receiving device are invalid or the receiving device is not authorized to decrypt the data, the authenticator 28 can deny the request for the decryption key.

Exemplary embodiments of the invention will now be described using several examples. As with many descriptions of communication protocols, names are assigned to the various devices (or individuals associated with those devices) used in the protocol. In one embodiment, Alice (A) and Bob (B) represent the first device 22 and the second device 24, respectively, and Trent (T) represents the authenticator 28, a trusted arbiter of communication (e.g., managed by the organization managing the intranet 21). In some examples, Carol (C) represents a third device included in the system 20 and connected to the intranet 21. The following table, Table 1, is a list of other symbols used in this document to explain multiple embodiments of the protocol.

TABLE 1

| Symbol | Meaning |
|---|---|
| A, B, C, T | Entities (e.g., devices) included in the system. |
| D | Digital content. |
| X_{id} | An identifier (e.g., public identifier) for an entity X. |
| X_{cred} | Secret information that identifies an entity X, which is |
| | known only to the entity X and the authenticator and is |
| | randomly assigned by the authenticator. |
| K_{X} | A key for a symmetric cipher associated with some |
| | entity X. |
| N_{X} | A one-use number associated with some key K_{X}. |
| H(X) | A function that produces a hash of X. |
| E(K, X) | A cipher that encrypts X with K. |
| X → Y: Z | A message Z sent from X to Y. |
| {(Nⁱ_{X}, Kⁱ_{X})} | A set of mutating IDs of arbitrary size associated with |
| | entity X. |

### Session Keys

In some embodiments, mutating IDs are used to exchange a communication or session key between two entities. For example, assume that Alice and Bob would like to communicate securely. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred} respectively) that are known only to Trent and the holder of the credentials.

In some embodiments, mutating IDs are used to exchange a communication or session key between two entities. For example, assume that Alice and Bob would like to communicate securely using a session key shared by Alice and Bob. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred}, respectively) that are known only to Trent and the holder of the credentials.

To request a session key (e.g., K_{AB}) from Trent, Alice encrypts her credentials A_{cred} and an identifier of Bob (e.g., B_{id}) with her secret key K_{A} and appends her number N_{A} to the result. Alice sends the message to Bob.

A→B:N_{A}E(K_{A}, A_{cred}B_{id})

Bob concatenates his credentials B_{cred} and an identifier of Alice (e.g., A_{id}) with the message from Alice and encrypts the result with his secret key K_{B}. Bob appends his number K_{B} to the result of the encryption and sends the resulting message to Trent.

B→T:N_{B}E(K_{B}, B_{cred}A_{id}N_{A}E(K_{A}, A_{cred}B_{id}))

Trent identifies that the message has come from Alice and Bob because Trent knows that the identifying numbers N_{A} and N_{B} are associated with Alice and Bob. Trent decrypts the message using the secret keys K_{A} and K_{B} associated with the identifying numbers N_{A} and N_{B}. To validate the message, Trent can verify multiple components of the message. For example, in one embodiment, Trent verifies that Bob's credentials B_{cred} are valid and match his number N_{B} and his identifier B_{id} provided by Alice and that Alice's credentials A_{cred} are valid and match her number N_{A} and her identifier A_{id} provided by Bob. If either Bob's or Alice's credentials are invalid or do not match the number provided by the owner of the credentials or do not match the identifier provided by the other entity, Trent can reject the request.

Once Trent identifies the entities involved in the message, Trent also verifies that Bob is authorized to communicate with or connect to Alice and that Alice is authorized to communicate with or connect to Bob. If Alice is not authorized to communicate with Bob or if Bob is not authorized to communicate with Alice, Trent can reject the request.

If Trent verifies the request, Trent generates a message for Alice and a message for Bob. The message for Alice includes a new number N_{A}′, a new secret key K_{A}′, Alice's credentials A_{cred}, and a session key K_{AB}. In addition, the message for Alice can include new credentials for Alice A_{cred}′. Trent encrypts the message for Alice with Alice's current secret key K_{A} and sends the message to Alice.

T→A:E(K_{A}, N_{A}′K_{A}′A_{cred}A_{cred}′K_{AB})

The message for Bob includes a new number N_{B}′, a new secret key K_{B}′, Bob's credentials B_{cred}, and a session key K_{AB}. In addition, the message for Bob can include new credentials for Bob B_{cred}′. Trent encrypts the message for Bob with Bob's current secret key K_{B} and sends the messages to Bob.

T→B:E(K_{B}, N_{B}′K_{B}′B_{cred}B_{cred}′K_{AB})

The above protocol can be extended to include more entities. For example, if Alice wants a session key associated with Bob and Carol, Alice can list known identifiers of Bob and Carol, such as Bob's identifier B_{id} and an identifier of Carol (e.g., C_{id}) in her message. Similarly, Bob can list identifiers of Alice and Carol, and Carol can list identifiers of Alice and Bob. Each entity can also include their credentials in their message. As shown above, each entity can forward their message to another entity associated with the requested session key and each entity can add their message to the received message. Once all the intended entities have added their message to the request, the last entity forwards the request to Trent. Trent verifies that the credentials of each entity match the mutating IDs assigned to each entity and that the list of identifiers specified by each entity match the provided credentials. Trent can also verify that each entity is authorized to communicate with each other entity involved in the message. After verifying the request, Trent sends a new mutating ID (e.g., a new number and a new identifying key) and the session key associated with the listed entities to each entity along with their credentials. Trent can also provide each entity with new or mutated credentials.

### Content Use Licenses

Mutating IDs can also be used to provide a license that an entity can use to obtain and decode a piece of content. For example, assume Alice has content or a message P that she wants to securely send to Bob. Again assume that Alice and Bob trust Trent and that Trent assigns Alice a mutating ID that includes a number N_{A} and a secret key K_{A} for some symmetric cipher and assigns Bob a mutating ID that includes a number N_{B} and a secret key K_{B} for some symmetric cipher. Also assume that Alice and Bob each have credentials (e.g., A_{cred} and B_{cred}, respectively) that are known only to Trent and the holder of the credentials.

To obtain a license for the message P, Alice generates a hash of the message P (e.g., H(P)), concatenates the message hash H(P) with her credentials A_{cred}, and encrypts the result with her secret key K_{A}. Alice also appends her number N_{A} to the encryption result. Alice sends the resulting license request to Trent.

A→T:N_{A}E(K_{A}, A_{cred}H(P))

Trent decrypts the license request from Alice and generates a response to Alice that includes a new mutating ID that includes a new number N_{A}′ and a new secret key K_{A}′ for Alice, a mutating ID to be associated with a license for the message P that includes a license number (e.g., N_{H(P)}) and a license secret key (e.g., K_{H(P)}), and an encryption key (e.g., K_{P}) for the message P. In some embodiments, Trent also includes the message hash H(P) in the response to Alice so that Alice can ensure that the message has not been tampered with (e.g., provided by an imposter). Trent encrypts the response with Alice's current secret key N_{A} and sends the encrypted response to Alice.

T→A:E(K_{A}, N_{A}′K_{A}′N_{H}(P)K_{H}(P)K_{P}H(P))

Once Alice obtains the response from Trent, Alice decrypts the response and obtains the key K_{P} and the mutating ID associated with a license for the message P. Alice encrypts the message P with the key K_{P} and generates a license for the encrypted message P. The license for the encrypted message P includes Alice's credentials A_{cred} and the message hash H(P). In some embodiments, the license also includes an identifier of the recipient of the license. For example, if Alice is going to send the license to Bob, the license can include an identifier of Bob (e.g., B_{id}). In some embodiments, an identifier of the recipient is excluded from the license in order to reduce the complexity of the protocol. For example, digital media production companies may not know ahead of time or track potential recipients of content.

Alice encrypts the license with the license secret key K_{H(P)} and appends the associated license number N_{H(P)} to the encryption result. Alice sends the encrypted message P and the associated license to Bob.

A→B:E(K_{P}, P)

A→B:N_{H}(P)E(K_{H}(P), A_{cred}H(P) B_{id})

At some point after receiving the encrypted message P and the associated license, Bob requests the decryption key for the encrypted message P. To generate a request for the decryption key, Bob concatenates his credentials B_{cred} to the license Alice provided and encrypts the result with his secret key K_{B}. Bob also appends his number N_{B} to the encrypted concatenation and sends the resulting request to Trent.

B→K:N_{B}E(K_{B}, B_{cred}N_{H}(P)E(K_{H}(P), A_{cred}H(P)B_{id}))

Trent unrolls the encryption, and, if an identifier of Bob is included in the license, Trent verifies that the credentials B_{cred} and the number N_{B} provided in the request match the identifier in the license Alice generated. Trent also verifies that the message hash H(P) included in the request matches the license number N_{H(P)} and the license secret key K_{H(P)}. After verifying the message from Bob, Trent sends Bob a decryption (e.g., K_{P}) that is used to decrypt the encrypted message P, a mutating ID that includes a new number N_{B}′ and a new secret key K_{B}′for Bob, and Bob's credentials B_{cred} all encrypted with Bob's current secret key K_{B}.

T→B:E(K_{B}, N_{B}′K_{B}′K_{P}B_{cred})

Optionally, Trent can inform Alice that Bob requested the decryption key.

T→A:E(K_{A}′, “Bob requested the key associated with the identifier H(P)”)

After providing the decryption key to Bob, the license Alice provided to Bob is no longer valid because Trent has already seen the license number N_{H(P)} and the license secret key K_{H(P)} associated with the one-time-use mutating ID associated with the license for the message P.

As in the previous example, this protocol can be extended to include multiple entities by having each entity add their credentials to the license, encrypt the result with their assigned mutating ID, and forward the modified license to the next entity. For example, if Alice generates and sends a license to Carol who forwards the license to David who then sends the license to Bob, the resulting license received by Trent would be as follows:

T→A:N_{B}E(K_{B}, B_{cred}N_{D}E(K_{D}, D_{cred}N_{C}E(K_{C}, C_{cred}N_{H}(P)E(K_{H}(P), A_{cred}H(P) B_{id}))))

### Device Authentication

The above protocol can also be used to perform other activities within the intranet 21, such as requesting encryption keys, requesting decryption keys, requesting that a message or data be forwarded to a particular device, requesting authorization to transmit data to a particular receiving device, requesting authorization to obtain or send data and/or requesting software from a particular device, authenticating a device to be connected to the intranet 21, etc. For example, in one embodiment, the protocol is used to authenticate a device before connecting the device to the intranet 21. As described above, given that the intranet 21 is managed internally by a specific organization for a controlled set of users, the organization can regulate the devices and the users of the devices connected to the intranet 21. For example, the authenticator 28 (and/or another authenticating device connected to the intranet 21) can authenticate a device connected to the intranet 21 (such as the devices 22 or 23) that makes a request to 1) connect to or communicate on the intranet 21, to 2) access data or files stored on the intranet (e.g., classified or confidential data such as trade secrets, financial information, and the like), or to 3) connect to another device (such as a computer storing a database) or an external network (such as the Internet) based on the identification of the requesting device (e.g., a device ID). The authenticator 28 can compare the identification of the device requesting connection to a list of validated device IDs. For example, the organization operating the intranet 21 can establish a list of device IDs for each device owned or managed by the organization that is capable of connecting to the intranet 21. If the identification of a device requesting a connection to the intranet 21 matches a device ID validated by the organization (and an access or communication permission is associated with the device ID), the authenticator 28 authorizes the device's connection to the intranet 21. In this way, it is possible to control access to certain information, files, and software on the intranet 21, and control the dissemination of such material both within the intranet 21 and beyond or outside of the intranet 21.

For example, assume Alice is a server connected to the intranet 21 with resources that Carol, a client computer connected to the intranet 21, wants to utilize. Let Bob represent a user of the client computer Carol who instructs Carol to use or access particular resources. Trent remains the authenticator for the protocol. Assume that Alice, Carol, and Bob all have an identifying number N and a secret key K assigned by Trent. Further, assume that Trent knows all secrets and that Alice, Carol, and Bob do not know each other's secrets. In addition, Alice, Carol, Bob, and Trent are all managed by the organization managing the intranet 21.

Since Alice may need to service many clients at once, Alice obtains a list of mutating IDs. Assuming that Alice already has an initial or current mutating ID assigned by Trent, Alice negotiates with Trent to get multiple mutating IDs. Alice first needs to prove to Trent that she is authorized to request multiple mutating IDs. To do this, Alice encrypts an identifier that Trent will recognize as belonging to Alice (e.g., A_{id} or A_{cred}) with a request for x mutating IDs with the secret key K_{A} of her current mutating ID and appends the identifying number of her current mutating ID to the encryption result. Alice sends the request to Trent.

A→T:N_{A}E(K_{A}, A_{cred} Send x mutating IDs)

Once Trent validates the request (e.g., validates Alice's credentials A_{cred} and verifies that Alice is authorized to submit the request), Trent generates x mutating IDs, encrypts the x mutating IDs with the secret key K_{A} of Alice's current mutating ID, and sends the encrypted x mutating IDs to Alice as shown in FIG. 3B. Trent can also provide Alice with new credentials A_{cred}′.

T→A:E(K_{A}, A_{cred}′{(N¹_{A}, K¹_{A})(N²_{A}, K²_{A}) . . . (N^{x}_{A}, N^{x}_{A})})

Since Alice used her current mutating ID, Alice destroys that mutating ID, and Trent marks the mutating ID as “used.” This protocol can be run at any time to ensure that a server or other type of device has enough mutating IDs to function correctly and/or efficiently.

A user, Bob, supplies his identifying credentials B_{cred} (e.g., a password, a user identifier, biometric information, etc.) to client software on the client computer, Carol. Carol encrypts Bob's credentials B_{cred} and her own identification (e.g., C_{id} or C_{cred}) with her current secret key K_{C} and appends her current identifying number N_{C} to the result. Carol and/or Bob can also specify a particular service and/or particular data to be obtained from Alice. Carol sends the result to Alice.

C→A: N_{C}E(K_{C}, B_{cred}C_{id})

Alice encrypts the message from Carol with a secret key K_{A}¹ of one of the x mutating IDs provided by Trent and appends the associated identifying number N_{A}¹ to the encryption result. Alice sends the resulting message to Trent.

A→T:N_{A}E(K_{A}, N_{C}E(K_{C}, B_{cred}C_{id}))

Trent decrypts the encrypted message received from Alice and determines that Bob, who is operating the client computer, Carol, would like to connect or use services resident on the server, Alice. Next, Trent validates Bob's credentials B_{cred} and Carol's identification C_{id} and determines whether Bob and/or Carol are authorized to use the services resident on the server, Alice. After Trent validates Bob's credentials B_{cred} and Carol's identification C_{id} and verifies that Bob and Carol are authorized to use the services provided by Alice, Trent generates two messages. The first message is destined for Carol and contains a new mutating ID (e.g., N_{C}′ and K_{C}), the identity of Alice A_{id}, and a session key K_{S}. In some embodiments, the first message also includes new credentials for Bob B_{cred}′ and/or a new identification for Carol C_{id}′. Trent encrypts the message for Carol with Carol's current secret key K_{C} and sends the resulting message to Carol.

T→C:E(K_{C}, A_{id}N_{C}′K_{C}′K_{S})

The second message is destined for Alice, the server, and contains an identity of Bob (e.g., B_{id}), the identification of Carol C_{id}, and the session key K_{S}. Trent encrypts the second message with Alice's current secret key K_{A} and sends the resulting message to Alice.

T→A:E(K_{A}, B_{id} C_{id}K_{S})

At this point, Carol knows that the session key K_{S} is safe to use to encrypt all communications exchanged with the Alice. Furthermore, Alice knows that the identities of Carol and/or Bob have been validated by Trent and that Carol and/or Bob are authorized to use the services Alice provides.

In some embodiments, Trent may authorize Bob to use the services provided by Alice even if the identification of Carol (e.g., C_{id} or C_{cred}) is not validated. For example, assume Bob is attempting to access or connect to a device connected to the intranet 21 from a remote or external device that is not owned or managed by the organization managing the intranet 21. The authenticator 28, therefore, may not recognize the identification of the external device as a valid device ID. If, however, Bob provides valid credentials (e.g., and is authorized to connect to devices connected to the intranet 21 from a remote device), Trent may authorize Bob's access to the intranet 21 and the devices connected thereto even if the external device does not have a valid device ID.

### Black Protocol

The secret keys of mutating IDs (e.g., K_{A}, K_{B}, and K_{C}) need to remain secret in order to protect the security of transmitted data encrypted with the secret keys. For example, if Trent provides Alice with a new mutating ID encrypted with Alice's current secret key (e.g., K_{A}), an eavesdropper who has determined Alice's current secret key can obtain Alice's new mutating ID. The eavesdropper can then use the new mutating ID to send false data and/or to obtain the plaintext of future data exchanged between Alice and Trent.

Eavesdroppers can determine (or attempt to determine) a key used to encrypt particular data by performing an attack. For example, an eavesdropper can perform a brute force attack. A brute force attack includes decrypting ciphertext with every possible key until a key is found that produces coherent or recognizable data (e.g., human readable data). If the eavesdropper obtains or knows the plaintext (or a portion or pattern thereof) corresponding to obtained ciphertext, the eavesdropper can more easily determine whether a correct candidate key has been found. For example, if the eavesdropper obtains ciphertext and knows that the ciphertext includes an individual's name followed by a 4-digit personal identification number (“PIN”), the eavesdropper can apply candidate keys until a candidate key produces the plaintext including the individual's name. The eavesdropper can then assume, with some certainty, that the remaining information included in the generated plaintext corresponds to the PIN.

However, if the eavesdropper has no knowledge of the plaintext or a pattern of the plaintext (i.e., has no content hint), the eavesdropper's ability to determine whether a correct candidate key has been found is greatly reduced and, perhaps, eliminated. For example, if plaintext includes a random number encrypted with a particular key, no matter how many keys the eavesdropper attempts in a brute force attack, the eavesdropper will have no way to determine whether candidate plaintext is the true plaintext corresponding to the ciphertext. Decrypting an encrypted random number with any candidate key will produce a random number that is equally likely to be the original random number as every other random number produced by every other candidate key.

Referring to the session key example described above involving Alice, Bob, and Trent, if any portion of an encrypted message is recognizable, known, becomes known, or includes any content hints, an eavesdropper could possibly perform a plaintext or partial-plaintext attack on the encrypted message and uncover a secret key of Alice or Bob used to encrypt the message. For example, assume that Alice sends the following message to Bob that is intercepted by an eavesdropper.

A→B:N_{A}E(K_{A}, A_{cred}B_{id})

The eavesdropper can perform a brute force attack on the intercepted message because Bob's identifier B_{id} and the format of the above message are known or public. Thus, the eavesdropper can obtain Alice's secret key K_{A} and her credentials A_{cred}. Furthermore, once the eavesdropper obtains Alice's current secret key K_{A}, the eavesdropper can use Alice's current secret key K_{A} to obtain all data encrypted with Alice's current secret key K_{A}, such as her next mutating ID (e.g., N_{A}′ and K_{A}′).

An eavesdropper can use other knowledge about an encrypted message or the communication protocol used to generate an encrypted message to perform brute force attacks. For example, an eavesdropper can use the mutating ID number (e.g., N_{A}), which is passed in the clear, to perform a brute force attack. An eavesdropper could also use knowledge of the algorithm used to generate the mutating ID numbers to perform a brute force attack.

As pointed out above, keys used to encrypt undiscoverable data (i.e., data that is random or has no content hints) cannot be easily determined or discovered using a brute force attack, since an eavesdropper will be unable to determine when a correct candidate key is found. Keys used to encrypt discoverable data (i.e., data that is known, may be later disclosed, is recognizable, or has a known or easily guessed format), however, can (theoretically) be determined using a brute force attack. When the discoverable data and the undiscoverable data are encrypted together or with the same encryption key (e.g., a recognizable name and a corresponding possibly random PIN encrypted with the same key), a key determined through a brute force attack using the discoverable data is also the key used to encrypt the undiscoverable data and, therefore, the undiscoverable data can be discovered.

To increase the security of the undiscoverable or secret data, separate keys can be used to encrypt the different types of data (hereinafter referred to as “separate encryption protocols”). For example, one or more keys (e.g., one or more mutating IDs) are used to encrypt the undiscoverable data (e.g., the secret keys K_{A}, K_{B}, and K_{C}) and one or more keys (e.g., one or more mutating IDs) are used to encrypt the discoverable data (e.g., B_{id}). Since the same keys are never used to encrypt undiscoverable data and discoverable data, the possibility of an eavesdropper determining undiscoverable date is reduced.

### Secure Digital Content Manipulation Management

Mutating IDs can also be used to control manipulation of digital content (e.g., documents, images, video, audio, etc.). For example, digital content may be confidential (e.g., a contract, a movie in production, payroll information, etc.) and, therefore, only particular entities (e.g., human users, computer applications, computer devices, etc.) may be allowed to access and/or modify the digital content. It should be understood that the terms “manipulate” and “manipulation,” as used in the present application, includes accessing and viewing digital content, modifying digital content, executing digital content, distributing digital content (e.g., copying digital content, transmitting digital content (e.g., emailing), storing digital content (e.g., to a disk or a flash memory device), etc. In some embodiments, mutating IDs may be used to manage manipulation of data stored in a device connected to the intranet 21 of FIG. 1.

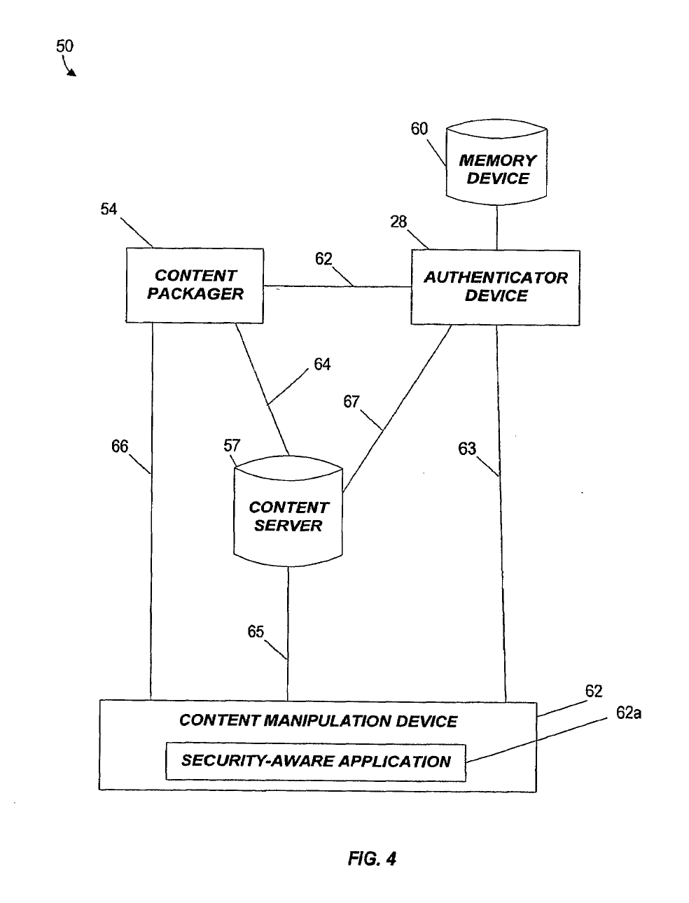

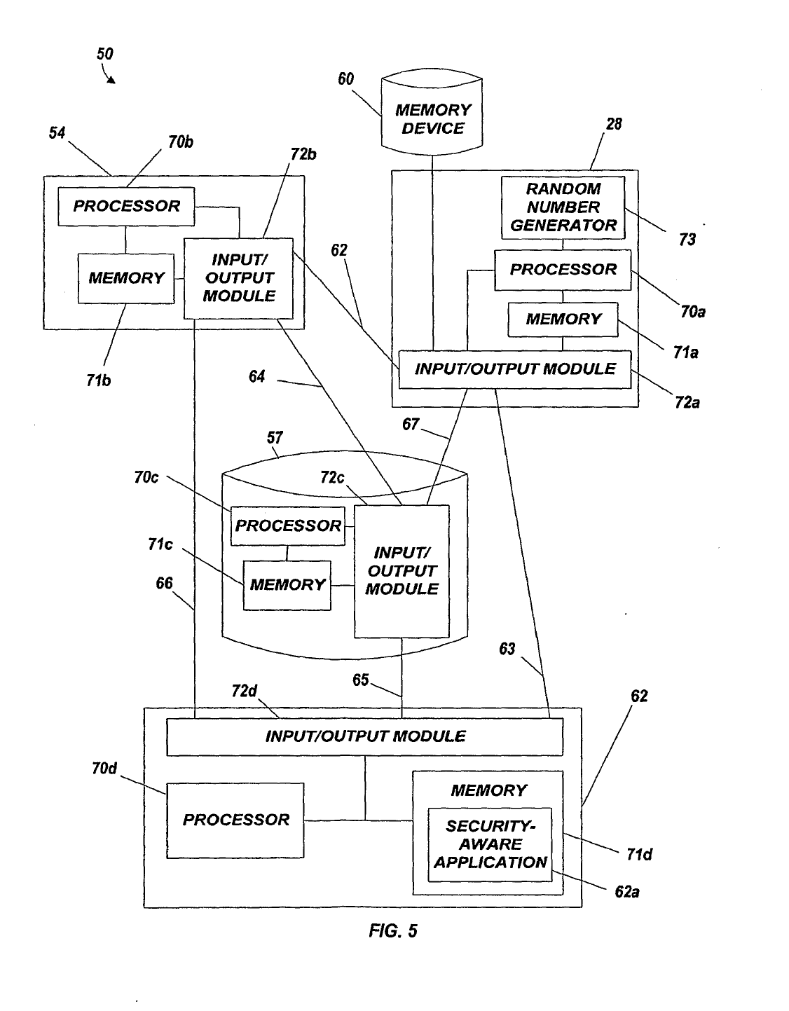

FIGS. 4 and 5 illustrate an exemplary system 50 configured to provide digital content management. In the embodiment shown in FIG. 4, the system 50 includes four participants or entities: an authenticator 28, a content packager 54, a content server 57, and a content manipulation device 62. Although only one content packager 54, content server 57, and content manipulation device 62 are shown in FIG. 4, in some implementations the system 50 may include multiple content packagers 54, content servers 57, and/or content manipulation devices 62. Further, there could be multiple authenticators 28. As shown in FIG. 4, in some embodiments, the authenticator 28 includes an external memory device 60. The memory device 60 stores mutating IDs managed by the authenticator 28.

In some embodiments, the content packager 54 and the content manipulation device 62 are connected to the authenticator 28 via communication links 63 and 64, respectively. The content packager 54 and the content manipulation device 62 are also connected to the content server 57 via communication links 64 and 65, respectively. In some embodiments, the content manipulation device 62 is also connected to the content packager 54 via communication link 66, and the authenticator 28 is connected to the content server 57 via communication link 67. The communication links 62, 63, 64, 65, and 66 can include two-way links and may be constructed from all or part of the networks mentioned above. In some embodiments, the communication links 62, 63, 64, 65, and 66 include communication links of an intranet.

FIG. 5 schematically illustrates the authenticator 28, the content packager 54, the content server 57, and the content manipulation device 62 according to one embodiment of the invention. As shown in FIG. 5, each apparatus includes a processor 70 (e.g., 70a, 70b, 70c, and 70d), a memory module 71 (e.g., 71a, 71b, 71c, and 71d), and an input/output module 72 (e.g., 72a, 72b, 72c, and 72d). It should be understood that the components shown in FIG. 5 are exemplary and can be combined and distributed in various arrangements and configurations. For example, a memory module 71 can be included in a processor 70 and/or an input/output module 72 in place of or in addition to being included as a separate component. The input/output modules 71 can also be located in a device external to the apparatus housing the corresponding processor 70.

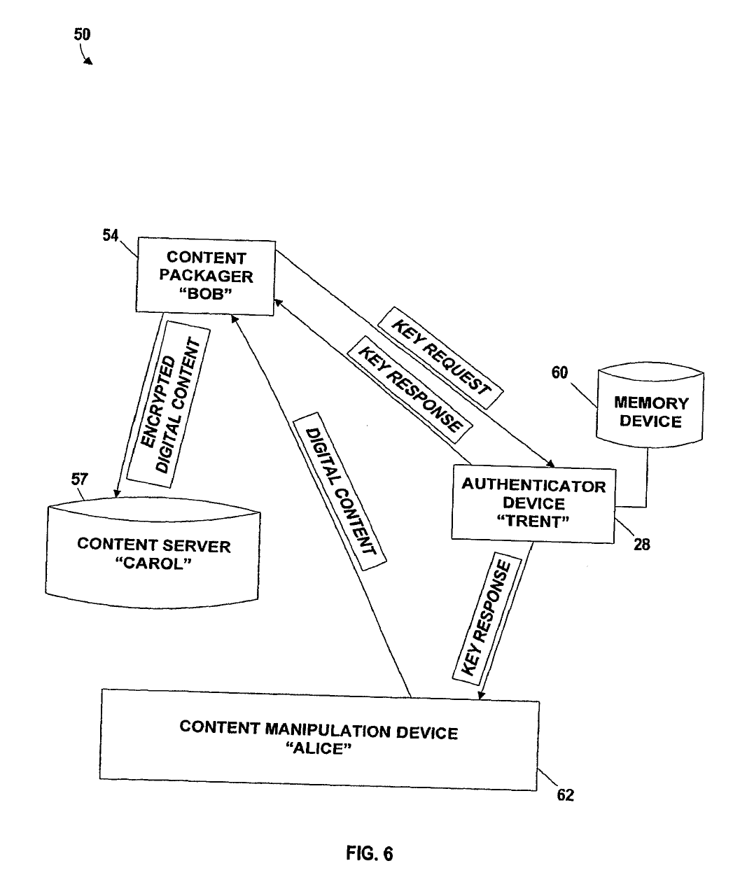

The processors 70 can include one or more processors or similar circuitry for managing the manipulation of digital content using mutating IDs. In one embodiment, the memory modules 71 store instructions and data retrieved and executed by the processor 70 for managing the manipulation of digital content using mutating IDs, as described below with respect to FIG. 6. The memory modules 71 can also store mutating IDs. In particular, the memory modules 71b, 71c, and 71d included in the content packager 54, the content server 57, and the content manipulation device 62, respectively, can be configured to store one or more mutating IDs assigned to each apparatus by the authenticator 28. Similarly, the memory module 71a included in the authenticator 28 can store the mutating IDs previously and currently assigned to each participant included in the system 50. In some embodiments, the memory module 71a included in the authenticator 28 also stores future mutating IDs awaiting assignment to a participant. As noted above, the authenticator 28 can also store mutating IDs to the external memory device 60.

The functions performed by each processor 70, and, consequently, the instructions and data stored in the memory module 71 of each participant, are configured based on the role a particular participant plays in managing the manipulation of digital content. The memory modules 71 can also store data received or transmitted by a particular participant via its input/output module 72.

As shown in FIG. 5, each participant includes an input/output module 72 that interfaces with at least one communication link. It should be understood that although each participant is shown connected to another participant by a single, direct connection, each participant is connected to another participant via one or more wired and/or wireless connections over one or more networks or communication systems, as described above. Each input/output module 72 can also interface with additional participants (e.g., networks, devices, etc.) over the same or additional communication links.

As directed by the processor 70, each input/output module 72 outputs data to another participant. Similarly, each input/output module 72 can receive data from another participant and forward the data to the associated processor 70 and/or memory module 71. As noted above, the input/output module 72 of a particular participant can be located in a device that is external to the device housing the processor 70 and/or the memory module 71 of the participant.

As shown in FIG. 5 and as described above with to FIG. 1, the authenticator 28 also includes a random number generator 73. The authenticator 28 uses the random number generator 73 to generate random numbers used in the protocol implemented or followed by the system 50 for managing the manipulation of digital content using mutating IDs. As noted above, the random number generator 73 can produce numbers that are truly random (i.e., numbers that are as random as is possible with the particular technology used to implement the invention).

In some embodiments, the functionality of the authenticator 28, the content packager 54, and/or the content server 57 is combined and provided by a single entity. Other functions performed by individual participants, as described below, can also be combined and distributed among the participants in various configurations.

As shown in FIGS. 4 and 5, the content manipulation device 62 executes at least one security-aware application 62a configured to create digital content and/or manipulate stored digital content (e.g., digital content stored in the content server 57). As described in more detail below, the application 62a performs various functions in order to control the manipulation of digital content. For example, as described below, based on the user of the application 62a, the application 62a may decrypt encrypted digital content and display the digital content to the user but may prevent the user from modifying the digital content or distributing the digital content (e.g., copying the digital content, transmitting the digital content (e.g., emailing the digital content), storing the digital content to a memory device (e.g., a disk or a flash memory device), etc.). As shown in FIG. 5, the security-aware application 62s is stored in the memory module 71d of the content manipulation device 62 and is retrieved and executed by the processor 70d of the content manipulation device 62.

If a user creates new digital content or modifies existing digital content using the application 62a, the application 62a (e.g., if the application 62a and/or the user operating the application 62a is authorized) stores the digital content to the content server 57. In some embodiments, as described below, the content packager 54 encrypts the digital content before the digital content is stored to the content server 57.

To access digital content stored in the content server 57, the application 62a requests access to digital content from the content server 57. In some embodiments, in response to the request, the content server 57 generates and transmits a use license to the device 62. The content manipulation device 62 forwards the use license to the authenticator 28, and the authenticator 28 determines whether the device 62 should be allowed access to the requested digital content. If the device 62 (e.g., the application 62a and/or the user operating the application 62a) is authorized to access the requested digital content, the authenticator 28 instructs the content server 57 to provide the digital content to the device 62. If the requested digital content is stored in the content server 57 in an encrypted form, the authenticator 28 also provides a decryption key to the device 62.

The authenticator 28 distributes mutating IDs to the participants, and the participants use the assigned mutating IDs to securely communicate with the authenticator 28 and other participants included in the system 50. As described below, the authenticator 28 can also generate and distribute encryption and decryption keys for digital content stored in the content server 57. Furthermore, in some embodiments, the authenticator 28 assigns credentials to each participant included in the system 50 that the authenticator 28 uses to verify messages received from participants.

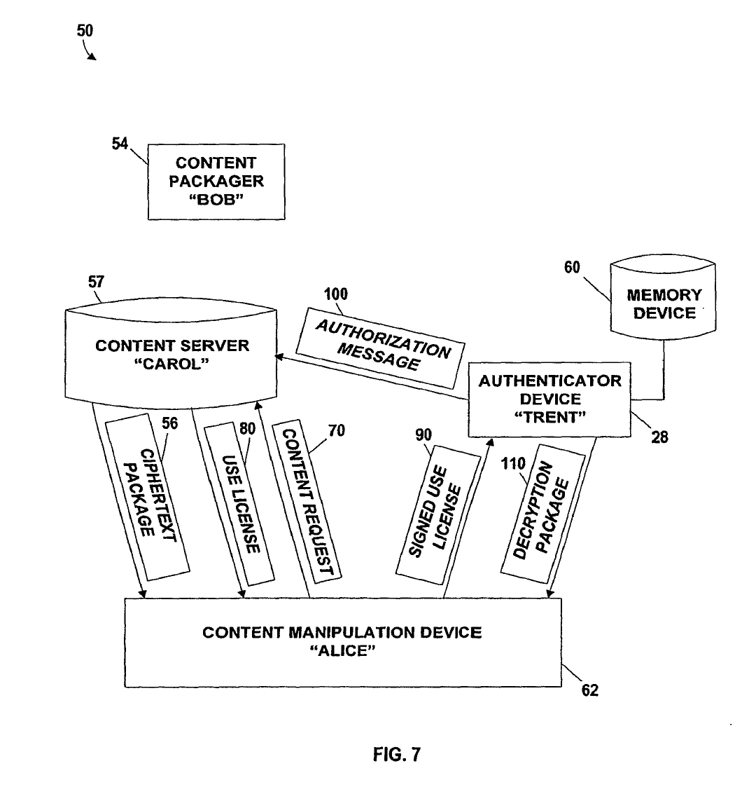

Examples of protocols for managing the manipulation of digital content within the system 50 are illustrated in FIGS. 6 and 7. In these examples, Alice (e.g., A) represents the content manipulation device 62 (e.g., the security-aware application 62a), Bob (e.g., B) represents the content packager 54, and Carol (e.g., C) represents the content server 57. Trent (e.g., T) represents the authenticator 28. The above table, Table 1, is a list of other symbols used to explain embodiments of the proposed protocol.

FIG. 6 illustrates a protocol for storing digital content. For this example, assume that Alice would like to store digital content (e.g., D) to the content server 57. In addition, assume that Alice previously received a secret key K_{A} and an identifying number N_{A} (i.e., a mutating ID) from Trent. Furthermore, assume Trent has previously assigned Bob a secret key K_{B} and an identifying number N_{B} and assigned Carol a secret key K_{C} and an identifying number N_{C}. In some embodiments, Trent also assigns Alice, Bob, and/or Carol credentials (e.g., A_{cred}, B_{cred}, C_{cred}, respectively) that each entity can include in messages. Trent uses the credentials to verify that messages were truly constructed by Alice, Bob, and/or Carol.

To store the digital content D, Alice forwards the digital content D to Bob. In some embodiments, Alice sends Bob the digital content D as plaintext. In other embodiments, Alice sends Bob the digital content D encrypted with her secret key K_{A} or another key, such as a session key (e.g., K_{AB}) previously established between her and Bob. It should be understood that in some embodiments the communication link between Alice and Bob is considered to be a secure communication link and, therefore, the digital content D can generally be transmitted securely between Alice and Bob as plaintext.

Alice can include additional information with the digital content D. In one example, Alice provides an identifier of the digital content (e.g., D_{id}). The identifier D_{id} includes a hash of the digital content D, a filename to be associated with the digital content D, etc. Alice provides Bob with the identifier D_{id} as plaintext, encrypted with a key known to Bob, or encrypted with a key unknown to Bob (e.g., her secret key K_{A}). In some embodiments, Alice also provides her credentials A_{cred} and encrypts her credentials A_{cred} with her secret key K_{A}. If Alice encrypts any portion of the information provided to Bob with her secret key K_{A}, Alice can append her identifying number N_{A} to the encryption result.

A→B:E(K_{AB}, D)

A→B:N_{A}E(K_{A}, D_{id}A_{cred})

As shown in the example messages above, in some embodiments Alice sends Bob the digital content D as plaintext or encrypted with a key known to Bob such that he can obtain the plaintext of the content D and can send the additional information (e.g., the identifier D_{id} and her credentials) to Bob encrypted with her secret key K_{A}. By encrypting some of the information provided to Bob with her secret key K_{A}, Alice can ensure that her message cannot be easily tampered with. It should be understood that other configuration and variations are also possible for providing Bob with the digital content D and the additional information.

After Bob receives the digital content and any additional information from Alice, Bob generates an encryption key request for Trent. In some embodiments, the key request includes the message Bob received from Alice. For example, the key request can include the digital content D Bob received from Alice. In other embodiments, if Alice provides Bob the digital content D as plaintext or encrypted in such a way that Bob can separate the encrypted content D from the remainder of the message received from Alice, the key request includes the additional information Bob received from Alice (e.g., the identifier D_{id} and/or Alice's credentials A_{cred}) but does not include the actual digital content D. In this way, Trent can be kept blind to the digital content that is being stored in the content server 57.

As noted above, the key request can include the identifier D_{id} of the requested content. In some embodiments, the key request only includes the identifier D_{id} Bob received from Alice. In other embodiments, if Alice did not provide an identifier D_{id}, Bob creates an identifier D_{id} and includes the identifier in the key request. For example, if Bob obtains the plaintext of the digital content D, Bob creates an identifier of the digital content using the same function or mechanism that Alice used to create her provided identifier D_{id}. In still other embodiments, if Bob creates an identifier for the digital content, Bob includes his identifier and Alice's provided identifier in the key request. Trent can use the identifiers provided by Alice and Bob to verify that the identifiers provided by each participant match. Bob can also include his credentials B_{cred} in the key request.

In some embodiments, Bob encrypts the key request with his secret key K_{B} and can append his identifying number N_{B} to the encryption result. Bob sends the resulting key request to Trent.

B→T:N_{B}E(K_{B}, D_{id}B_{cred}N_{A}E(K_{A}, D_{id}A_{cred})

Trent identifies that the key request has come from Bob and Alice because Trent knows that the number N_{B} is associated with Bob and that the number N_{A} is associated with Alice. Trent decrypts the key request using K_{B} and K_{A}. In some embodiments, if Alice and/or Bob provided credentials, Trent verifies the credentials. If the credentials are not valid (e.g., they do not match the credentials currently assigned to Alice and/or Bob), Trent declines the key request and sends a decline message to Bob and/or Alice.

Trent can also verify additional information, or a portion thereof, included in the key request. In one example, Trent verifies that the identifiers of the digital content received from Bob and Alice match. If the identifiers do not match, Trent declines the key request and sends a decline response to Bob and/or Alice. In addition, if Trent declines the key request, Trent provides Alice and Bob with new mutating IDs.

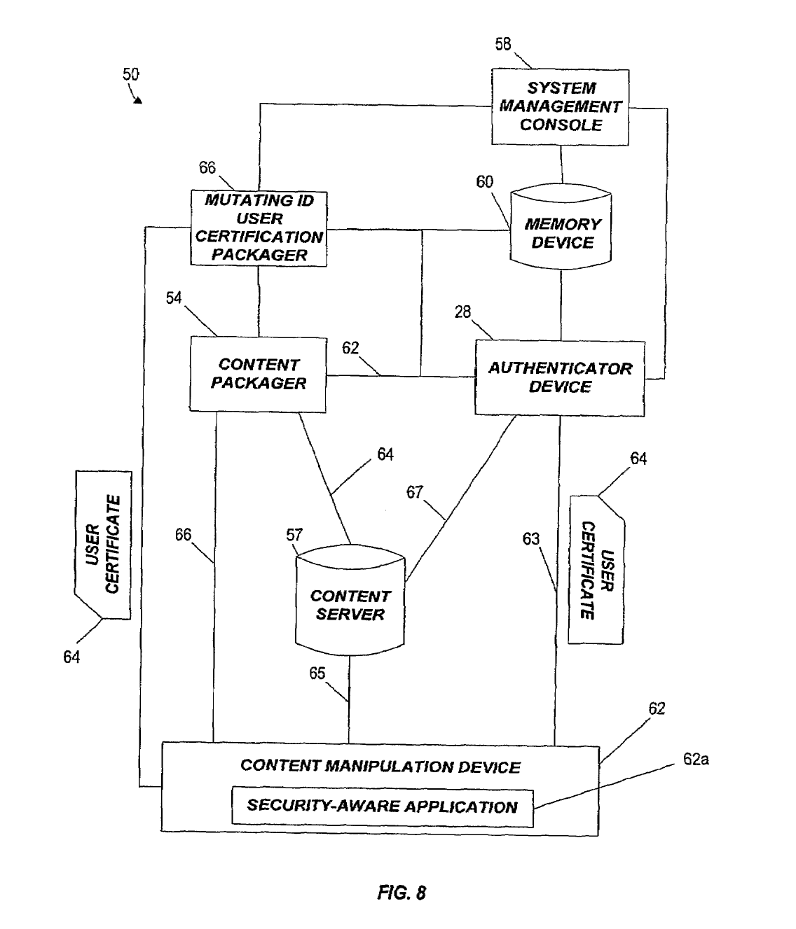

In some embodiments, Trent also verifies that Alice is authorized to store digital content to the content server 57. As described below with respect to FIG. 8, the authenticator 28 and/or a separate device manages a list of entities that are authorized to store digital content to the content server 57. In some embodiments, a manager of the digital content (e.g., a manager of the system 50) specifies which entities are authorized to store digital content to the content server 57. In other embodiments, any entity that is authorized to communicate with Trent (e.g., has a valid mutating ID) is automatically authorized to store digital content to the content server 57.

If Trent verifies the information included in the key request, Trent generates a key response for Bob. The key response includes an encryption key (e.g., K_{D}) for the digital content D (e.g., randomly chosen by Trent). Trent stores the encryption key K_{D} and the identifier D_{id} of the digital content included in the key request.

In some embodiments, Trent encrypts the key response with Bob's secret key K_{B}. The key response can also include additional information, such as the identifier D_{id} of the digital content, Bob's credentials B_{cred}, and/or a new mutating ID for Bob (e.g., N_{B}′ and K_{B}′)

T→B:E(K_{B}, K_{D}D_{id}B_{cred}N_{B}′K_{B}′)

Bob decrypts the key response from Trent and verifies the information included in the message. For example, Bob can verify that the identifier D_{id} provided by Trent matches the identifier Bob provided to Trent. Bob can also verify that his credentials B_{cred} included in the response are valid.

After verifying the key response from Trent, Bob uses the encryption key K_{D} included in the key response to encrypt the digital content D. After encrypting the digital content D, Bob sends the encrypted content to Carol for storage. Bob also sends Carol the identifier D_{id} associated with the digital content D, as plaintext, encrypted with the encryption key K_{D}, or encrypted with another key shared between Bob and Carol, such as a previously-established session key.

B→C:D_{id}E(K_{D}, D)

Carol stores the encrypted digital content and the associated identifier D_{id}. Storing the digital content D in an encrypted form helps prevent an unauthorized user from obtaining plaintext digital content if the unauthorized user obtains access to the content server 57.

Trent also generates and sends a key response to Alice. In some embodiments, if Alice used her mutating ID when she sent the digital content D and/or the additional information to Bob, Trent includes a new mutating ID (e.g., N_{A}′ and K_{A}′) for Alice in the key response. The key response for Alice also includes the identifier D_{id} of the digital content and/or Alice's credentials A_{cred}. Alice uses the identifier and/or the credentials to verify that her request to store the digital content D is being processed and that the message was generated by Trent. In some embodiments, Trent also sends Alice the encryption key K_{D} (and/or the decryption key, if different) assigned to the digital content D. Alice uses the decryption key (e.g., the symmetric encryption key) to decrypt the encrypted digital content if she retrieves the stored content from Carol. In this way, Alice can retrieve and decrypt the stored digital content at a later time without having to request the decryption key from Trent. In other embodiments, Alice is not informed of the encryption key K_{D} (and/or the decryption key, if different) in order to control her further access to the digital content D.

T→A:E(K_{A}, D_{id}A_{cred}N_{A}′K_{A}′)

It should be understood that, in some embodiments, Alice generates and transmits a key request to Trent rather than Bob. In addition, as noted above, the functions of the authenticator 28, the content packager 54, and the content server 57 can be combined such that separate messages between Bob and Trent are not necessary to obtain an encryption key for the digital content D.

After the digital content D is stored to the content server 57, a user of the content manipulation device 62 can use the application 62a to request access to the stored content D.

FIG. 7 illustrates one example protocol for obtaining or accessing digital content stored in the content server 47. For this example, assume that Alice wants to access digital content D stored by Carol. In addition, assume that Alice previously received a secret key K_{A} and an identifying number N_{A} (i.e., a mutating ID) from Trent. Furthermore, assume Trent has previously assigned Bob a secret key K_{B} and an identifying number N_{B} and assigned Carol a secret key K_{C} and an identifying number N_{C}. In some embodiments, Trent also assigns Alice, Bob, and/or Carol credentials (e.g., A_{cred}, B_{cred}, C_{cred}, respectively) that each entity can include in messages. Trent uses the credentials to verify that messages were truly constructed by Alice, Bob, and/or Carol.

As shown in FIG. 7, to request access to the digital content D, Alice generates and transmits a content request 78 to Carol. The content request 78 includes an identifier of the digital content D (e.g., D_{id}). The identifier D_{id} can include a hash of the digital content D, a filename associated with the digital content, or another identifier that uniquely identifies the digital content D. The content request 78 can also include additional information, such as Alice's credentials A_{cred} or other identifying information. In some embodiments, Alice encrypts the content request 78, or a portion thereof, with her secret key K_{A} and appends her identifying number N_{A} to the encryption result. In other embodiments, Alice sends the content request 78, or a portion thereof, as plaintext.

A→C:D_{id}

After Carol receives the content request 78 from Alice, Carol generates a use license 80 or content identifier for the requested content. The use license 80 includes the identifier D_{id} of the requested digital content (e.g., the identifier received from Alice and/or an identifier generated by Carol). In some embodiments, the use license 80 also includes Carol's credentials C_{cred}. Carol encrypts the use license 80 with her secret key K_{C} and appends her identifying number N_{C} to the encryption result. Carol encrypts the use license 80 in order to prevent the license from being tampered with. In some embodiments, Carol obtains multiple mutating IDs, as described above with respect to FIG. 3, in order to service many requests for digital content from one or more content manipulation devices 62. Carol can also create a supply of one or more use licenses 80 (e.g., for a particular piece of content) before receiving the content request 78 from Alice. Carol sends the use license 80 to Alice.

C→A:N_{C}E(K_{C}, D_{id}C_{cred})

Upon receiving the use license 80 from Carol, Alice generates a signed use license or content request 90 for Trent. In some embodiments, Alice generates the signed use license 90 by encrypting the use license 80 with her secret key K_{A} and appending her identifying number N_{A} to the encryption result. Alice can also concatenate additional information to the use license 80 before encrypting the use license 80 with her secret key K_{A}. In one example, Alice concatenates the identifier D_{id} of the requested content and/or her credentials A_{cred} to the use license 80 before encrypting the use license 80 with her secret key K_{A}. Alice sends the resulting signed use license 90 to Trent.

A→T:N_{A}E(K_{A}, D_{id}A_{cred}N_{C}E(K_{C}, D_{id}C_{cred})

It should be understood that, in some embodiments, Carol creates a use license 80 based on information contained in the content request 78 received from Alice in such a manner that the use license 80 already includes Alice's information and/or “signature.” For example, in her content request 78, Alice includes the identifier D_{id} of the digital content and her credentials A_{cred} encrypted with her secret key K_{A} and concatenated with her identifying number N_{A}. Carol concatenates the use license information (e.g., the identifier D_{id} of the digital content and/or her credentials C_{cred}) to the encrypted information received from Alice and encrypts the concatenation result with her secret key K_{C} and appends her identifying number N_{C} to the encryption result. Carol then forwards the use license 80 to Trent without requiring additional information from Alice.

Upon receiving the signed use license 90 from Alice (or from Carol, if applicable), Trent identifies that the signed use license 90 was generated by Carol and Alice because Trent knows that the number N_{C} is associated with Carol and that the number N_{A} is associated with Alice. Trent decrypts the signed use license 90 using K_{C} and K_{A} and obtains the information contained in the use license 80 and the additional information provided by Alice. In some embodiments, if Alice and/or Carol provided credentials, Trent verifies the credentials. If the credentials are not valid (e.g., they do not match the credentials currently assigned to Alice and/or Carol), Trent declines the signed use license 90 and sends a decline response to Carol and/or Alice. Trent can also verify additional information included in the signed use license 90. In one example, Trent verifies that the identifiers of the digital content received from Carol and Alice match. If the identifiers do not match, Trent declines the signed use license 90 and sends a decline response to Carol and/or Alice. In some embodiments, if Trent declines the signed use license 90, Trent provides Alice and Carol with new mutating IDs.

In some embodiments, Trent also verifies that Alice and/or a user operating Alice is authorized to access digital content stored in the content server 57. As described below with respect to FIG. 8, the authenticator 28 and/or a separate device manage a list of entities that are authorized to access digital content stored in the content server 57. In some embodiments, a manager of the digital content (e.g., a manager or organization of the system 50) specifies which entities are authorized to access digital content stored in the content server. In other embodiments, any entity that is authorized to communicate with Trent (e.g., has a valid mutating ID) is automatically authorized to access digital content stored in the content server 57.

If Trent verifies the information contained in the signed use license 90, Trent generates an authorization message 100. The authorization message 100 can include the use license 80, or information contained therein, such as the identifier D_{id} of the requested digital content. The authorization message 100 can also include credentials and/or identifiers of Alice and/or Carol. For example, in some embodiments, the authorization message 100 includes a public or non-secret identifier of Alice (e.g., A_{id}) and Carol's credentials C_{cred}, which are known only to Trent and Carol. Carol uses the public identifier of Alice A_{id} to identify which entity has been authorized to receive the requested content and uses the credentials C_{cred} to verify that the authorization message 100 was generated by Trent. In some embodiments, the authorization message 100 also includes a new mutating ID for Carol (e.g., K_{C}′ and N_{C}′). Trent encrypts the authorization message 100 with Carol's secret key K_{C} and sends the encryption result to Carol, and, in some embodiments, Trent appends Carol's identifying number N_{C} to the encryption result.

T→C:E(K_{C}, D_{id}A_{id}B_{cred}K_{C}′N_{C}′)

The authorization message 100 informs Carol that Alice has been authorized to access the requested digital content D and instructs Carol to send Alice the requested digital content D. As described above with respect to FIG. 6, the digital content D is stored in the content server 57 in an encrypted form. Therefore, Carol sends Alice the requested digital content D in an encrypted form (e.g., as a ciphertext package 56). In some embodiments, Carol also sends Alice additional information, such as the identifier D_{id} of the requested content.

C→A:E(K_{D}, D)

In addition to sending the authorization message 100 to Carol, Trent sends Alice a decryption package 110. The decryption package 110 includes the decryption key K_{D} associated with the requested digital content D. As described above with respect to FIG. 6, the authenticator 28 generates the encryption keys for digital content stored in the content server 57 and stores the encryption key for each piece of digital content along with an associated identifier. Therefore, Trent uses the identifier D_{id} included in the use license obtained from Alice and Carol to determine and obtain the decryption key (e.g., the symmetric encryption key) for the requested content D. The decryption package 110 can also include addition information, such as the identifier D_{id} of the requested content and/or a new mutating ID for Alice (e.g., K_{A}′ and N_{A}′). Trent encrypts the decryption package 110 with Alice's current secret key K_{A} and, in some embodiments, appends Alice's identifying number N_{A} to the encryption result.

T→A:E(K_{A}, D_{id}K_{D}K_{A}′N_{A}′)

After Alice receives the encrypted digital content D from Carol (e.g., the ciphertext package 56) and receives the decryption package 110 from Trent, Alice decrypts the encrypted requested content D with the decryption key included in the decryption package 110 and manipulates (e.g., displays) the digital content D as desired or authorized.

If Alice modifies the digital content D, Alice stores the modified digital content D to the content server 57. In some embodiments, Alice requests a new encryption key for the modified digital content, as described above with respect to FIG. 6. In other embodiments, Alice uses the decryption key received from Trent to encrypt the modified digital content and transmits the encrypted modified digital content to the content server 57 for storage.

It should be understood that the steps and/or order of the protocol described above and illustrated in FIG. 7 can be modified. For example, Carol can send Alice the encrypted requested content before sending a use license and/or before receiving an authorization message from Trent. Upon receiving the encrypted content from Carol, Alice requests the decryption key from Trent, and, if Trent approves Alice's access of the requested content, Trent sends the decryption key to Alice and does not necessarily need to send an authorization message to Carol. In this way, Carol can automatically send encrypted content to Alice upon receiving a content request and does not need to be involved in the remainder of the approval process. Even if Trent ultimately declines Alice's request for the decryption key associated with the requested digital content, Alice has not obtained any useful information since the content received from Carol is encrypted.

As described above with respect to FIGS. 6 and 7, the authenticator 28 verifies that a particular entity is authorized to store digital content to the content server 57 and/or access digital content stored in the content server 57. In one example, the authenticator 28 uses information obtained in request to store content to or retrieve content from the content server 57 (e.g., a mutating ID or credentials) to identify the entity making the request and verifies that the identified entity is authorized to perform the requested function (e.g., compare the identified entity to a list of authorized entity). If the entity is not authorized to perform the requested function, the authenticator 28 declines the request.

In some embodiments, the authenticator 28 (or another device included in the system 50) also manages additional rights associated with digital content. For example, a particular entity may be assigned particular rights associated with particular digital content. The rights govern whether the entity can access or view the digital content, execute the digital content, modify (e.g., edit) the digital content, distribute the digital content (e.g., copy the digital content, email the digital content, or store the digital content to a memory device), etc.

As shown in FIG. 8, in some embodiments, the system 50 includes a system management console 58. The system management console 58 is connected to the content packager 54, the authenticator 28, and/or the memory device 60. An owner, creator, or other manager of digital content 52 (e.g., a manager of the organization or system 50) uses the system management console 58 to specify access controls for digital content stored in the content server 57. For example, a manager of digital content can specify users that can access digital content stored in the content server 57 and/or user that can store digital content in the content server. In addition, a manager of digital content can use the system management console 58 to enter specific access controls or rights for each user that is allowed access to digital content stored in the content server 57. The access controls or rights can include read-only rights, read-and-write rights, read-write-and-execute rights, distribution rights, copying rights, etc. In some embodiments, the access controls apply to all digital content accessed by a particular entity. In other embodiments, specific access controls are specified for particular digital content accessed by all or any particular entity and/or accessed by particular entities. For example, a manager of a particular piece of digital content can specify that all entities included in the system 50 can access the piece of digital content but can specify that only certain entities can modify and/or distribute the piece of digital content.

The authorized users and/or the access controls provided by a manager of digital content via the system management console 58 are stored in the memory device 60. As described above, the memory device 60 can also store keys (e.g., symmetric encryption and decryption keys and/or encryption keys and corresponding decryption keys) used to encrypt and/or decrypt digital content stored in the content server 57 and mutating IDs assigned to entities of the system 50. In some embodiments, the memory device 60 also stores an audit log or other information as to when digital content was created, encrypted, stored, accessed, executed, modified, distributed, etc.

For example, if a user creates digital content and stores the digital content to the content server 57, the user uses the system management console 58 to specify access rights associated with the digital content. The access rights specify what entities (e.g., users, devices, etc.) can access or retrieve the digital content and/or, of those entities authorized to access the content, what rights particular entities have associated with the digital content. For example, the user can specify that another user can access the digital content but cannot modify the content or distribute the content. The system management console 58 stores the access rights specified by the user to the memory device 60.

As described above with respect to FIG. 7, when a user wants to access digital content stored in the content server 57, the user uses a content manipulation device 62 to execute the security-aware application 62a. The security-aware application 62a performs various functions in order to protect digital content 52 from being viewed, edited, and/or executed based on the authorized and/or unauthorized functions specified by access rights associated with the digital content 52. For example, the security-aware application 62a can decrypt the digital content 52, can prevent a user from editing the digital content 52, can prevent a user from executing digital content, can prevent a user from copying the digital content 52, can prevent the user from distributing the digital content 52 (e.g., emailing the digital content or storing the digital content 52 to an authorized storage device), etc.

As shown in FIG. 8, in some embodiments, prior to or upon loading the application 62a, the application 62a obtains a mutating ID or user certificate 64. In some embodiments, the authenticator 28 creates and distributes the user certificate 64. The user certificate 64 identifies a user of the application 62a and, in some embodiments, is assigned in addition to the mutating ID assigned to the content manipulation device 62. In one embodiment, the user certificate 64 is different from (e.g., completely unrelated to) the mutating ID assigned to the content manipulation device 62. In some embodiments, the user certificate 64 includes an identifying number and a secret key (e.g., a mutating ID). The user certificate 64 can also be associated with credentials, access rights, and other information stored in the memory device 60 that is associated with the application 62a and/or the user of the application 62a. For example, a user of the application 62a can provide identification and/or, authentication information (e.g., a password, a username, biometric information, etc.) and the application 62a and/or the content manipulation device 62 can forward the user information to the authenticator 28. The authenticator 28 uses the user information when creating the user certificate 64.

As noted above, in some embodiments, the authenticator 28 creates and distributes the user certificate 64. In other embodiments, a mutating ID/user certificate packager 66 creates the user certificate 64 based on information obtained from the authenticator 28, the system management console 58, and/or the content manipulation device 62 and/or information stored in the memory device 60 (see FIG. 8). After creating the user certificate 64, the mutating ID/user certificate packager 66 distributes the user certificate 64 to the content manipulation device 62 and, in particular, the application 62a.

After the application 62a obtains the user certificate 64, the application 62a includes the user certificate 64, and/or information contained therein, in requests and/or messages exchanged between entities included in the system 50. In one example, the application 62a generates a content request 90 by encrypting the use license 80 received from the content server 57 with a secret key of the user certificate 64 and appending an identifying number of the user certificate 64 to the encryption result. In some embodiments, the application 62a also encrypts the use license 80 with the secret key of the mutating ID assigned to the content manipulation device 62 and appends the corresponding number to the encryption result. In this way, the signed use license 90 includes identifying information of the content manipulation device 62 and the user of the device 62, and the authenticator 28 can verify the access rights of both the device 62 and the user 62 before approving access to particular digital content. In other embodiments, the application 62a only encrypts the content request with the secret key of the user certificate 64.

When the authenticator 28 receives the encrypted use license, it uses the secret key of the user certificate 64 and the identifying number of the user certificate 64 to identify the entity (e.g., the application 62a and/or the user of the application 62a) requesting the digital content. After determining the identity of the entity requesting the digital content, the authenticator 28 determines whether the entity requesting the digital content has the appropriate access rights for obtaining the requested digital content. In some embodiments, the authenticator 28 obtains access rights stored in the memory device 60 in order to determine whether the requesting entity has the appropriate rights to access the requested digital content. If the requesting entity does not have the appropriate access rights to access the requested digital content, the authenticator 28 declines the content request and sends a decline response to the content manipulation device 62 and/or the content server 57.

If the requesting entity has appropriate rights to access the requested digital content, when the authenticator 28 generates the authorization message 100 and/or the decryption package 110 for the content server 57 and/or the content manipulation device 62, the authenticator 28 includes the access rights associated with the requesting entity and/or the requested digital content. In some embodiments, the decryption package 110 generated by the authenticator 28 includes access rights that specify how and if the security-aware application 62a should allow the user to view, edit, and/or execute the requested digital content. For example, the instructions can specify that the application 62a should only allow a user to view the digital content, that the content manipulation device 62 should allow a user to view and edit the digital content, that the content manipulation device 62 should allow a user to execute the digital content, that the content manipulation device 62 should prevent a user from distributing (e.g., emailing, storing to an external memory device, etc.) the digital content, etc.

In some embodiments, the authenticator 28 only includes access rights in the decryption package 110 if specific access rights are associated with the requesting entity and/or the requested digital content. For example, if an entity is authorized to access particular digital content and no other access rights are defined for the entity and/or the digital content, the authenticator 28 generates a decryption package 110 that does not include any access rights or instructions. A decryption package devoid of access rights indicates to the application 62a that the entity can perform any or all functions on the digital content.

Rather than including the access rights or instructions in the decryption package 110, the authenticator 28 can provide the access rights or instructions to the content manipulation device 62 as a separate message or package. In some embodiments, the system management console 58 or the mutating ID user certificate packager 68 provides the access rights, or a portion thereof, to the content manipulation device 62. The access rights can be provided as plaintext or encrypted or protected with a key known to the application 62a and/or the content manipulation device 62.

When the application 62a receives the ciphertext package 56 from the content server 57 and receives the decryption package 110 from the authenticator 28, the security-aware application 62a decrypts the ciphertext package 56 and displays the decrypted digital content based on the access rights provided in the decryption package 110 (or obtained separately). For example, the security-aware application 62a can display the decrypted digital content in a read-only version, a read-and-write version, a read-write-and-execute version, etc. If the user of the application 62a attempts to perform a function on the digital content that is not allowed based on the provided access rights, the application 62a can generate a warning indication that informs the user that he or she is not authorized to perform the attempted function. The warning indication can include a visual message, an audible sound, etc.

In some embodiments, decrypted digital content is only available to the application 62a and is protected from outside applications requesting and obtaining the decrypted digital content. In addition, the application 62 can prevent the user from copying digital content or distributing the digital content (e.g., emailing, saving to a disk or another unauthorized storage device, etc.) based on the access rights included in the decryption package 110 or as default behavior.

If the access controls associated with digital content obtained by the application 62a change while a user is viewing, editing, and/or executing the digital content, the authenticator 28, the system management console 58, and/or the mutating ID user certificate packager 66 can inform the application 62a of the change(s) (e.g., in approximately real-time), and the application 62a can modify its operation accordingly.

In some embodiments, a user certificate 64 is only used once (e.g., for one content manipulation request). Therefore, after an assigned user certificate 64 is used, the authenticator 28, the system management console 58, and/or the mutating ID user certificate packager 66 provide the content manipulation device 62 (e.g., the application 62a) with a new user certificate 64. In some embodiments, the authenticator 28 prompts the user, the application 62a, and/or the content manipulation device 62 to provide authentication information before the authenticator 28 generates and provides a new user certificate 64. In this way, the authenticator 28 can guarantee that an authorized user is operating the application 62a throughout the use of the application 62a.

It should be understood that the functions performed by the authenticator 28, the system management console 58, and/or the mutating ID user certificate packager 66 can be combined and distributed in various configurations. For example, the functions provided by the authenticator 28, the system management console 58, and the mutating ID user certificate packager 66 can be combined and provided by a single entity or device. The memory device 60 can also be constructed using multiple devices, some of which can be combined with the authenticator 28 and/or the system management console 58.

It should be also understood that the above protocols can be used in various types of networks. For example, the protocols can be used to manage manipulation of digital content stored and distributed within an intranet-based system, such as the system 20 shown in FIG. 1. The above digital content management protocols can also be used when a user is requesting and receiving digital content from a database or server over a public network, such as the Internet.

Furthermore, it should be understood that other communication and transaction protocols (or portions thereof) involving mutating IDs, such as the protocols described above with respect to session keys, content use licenses, device authentication, and discoverable and undiscoverable data, can be combined with the proposed digital content manipulation management protocols. For example, obtaining digital content can be included in digital content purchases from a content provider or a service provider and the transaction can be conducted using mutating IDs. Additionally, digital content accessed by a user can be watermarked to guarantee unique digital content. Furthermore, the messages exchanged between the participants of the system 50 can use separate encryption protocols, as described above, and encrypt discoverable data and undiscoverable data with separate, unrelated keys in order to decrease the effectiveness of brute force attacks on messages passed between Alice, Bob, Carol, and Trent. Other combinations and configurations are also possible.

Various features of embodiments of the invention are set forth in the following claims.

1. A method of managing manipulation of digital content stored in a content server, the method comprising:
receiving a first mutating identifier at a content manipulation device, the first mutating identifier including a first secret key;
generating a content request for digital content stored in the content server at the content manipulation device, the content request encrypted with the first secret key and including an identifier of the digital content;
transmitting the content request to an authenticator over at least one communication link;
transmitting access rights from the authenticator to the content manipulation device over at least one communication link;
transmitting the digital content from the content server to the content manipulation device;
manipulating the digital content at the content manipulation device based on the access rights; and
marking the first mutating identifier as used at the authenticator.

2. The method of claim 1, further comprising generating a package at the authenticator and transmitting the package to the content manipulation device over at least one communication link, the package encrypted with the first secret key.

3. The method of claim 2, wherein generating a package at the authenticator includes generating a package including a second mutating identifier, the second mutating identifier including a second secret key.

4. The method of claim 2, wherein generating a package at the authenticator includes generating a package including a decryption key for the digital content.

5. The method of claim 2, wherein generating a package at the authenticator includes generating a package including the access rights.

6. The method of claim 5, wherein transmitting access rights to the content manipulation device includes transmitting the access rights to the content manipulation device in the package.

7. The method of claim 1, further comprising encrypting the access rights with the first secret key prior to transmitting the access rights from the authenticator to the content manipulation device.

8. The method of claim 1, wherein receiving a first mutating identifier at a content manipulation device includes receiving a user certificate at the content manipulation device, the user certificate including the first mutating identifier and associated with a user of the content manipulation device.

9. The method of claim 8, further comprising receiving user information at the content manipulation device from the user of the content manipulation device.

10. The method of claim 9, further comprising transmitting the user information to the authenticator; and generating at the authenticator the user certificate based on the user information.

11. (canceled)

12. The method of claim 8, wherein generating a content request for digital content stored in the content server at the content manipulation device includes generating a content request including at least a portion of the user certificate, and further comprising verifying the content request at the authenticator.

13. (canceled)

14. (canceled)

15. (canceled)

16. The method of claim 1, wherein transmitting access rights from the authenticator to the content manipulation device includes transmitting access rights including at least one of view access rights, modify access rights, execute access rights, and distribute access rights from the authenticator to the content manipulation device.

17-23. (canceled)

24. A system for managing manipulation of digital content stored in a content server, the system comprising:
an authenticator configured to assign a first mutating identifier to a content manipulation device; and
the content manipulation device configured to generate a content request for digital content stored in the content server, the content request encrypted with a first secret key and including an identifier of the digital content; to transmit the content request to the authenticator over at least one communication link; to receive a package from the authenticator encrypted with the first key and including access rights over at least one communication link; to receive the digital content from the content server over at least one communication link; and to manipulate the digital content based on the access rights, the authenticator configured to generate the package including the access rights, the access rights associated with at least one of the content manipulation device and the digital content, and to mark the first mutating identifier as used.

25. The system of claim 24, wherein the content request includes credentials of the content manipulation device.

26. The system of claim 24, wherein the content manipulation device receives a user certificate including identifying information of a user of the content manipulation device.

27-50. (canceled)

51. An authenticator for managing manipulation of digital content stored in a content server, the authenticator comprising:
a memory module configured to store a first mutating identifier assigned to the content manipulation device, the first mutating identifier including a first secret key;
an input/output module configured to receive a content request for digital content from the content manipulation device over at least one communication link, the content request encrypted with the first secret key; and
a processor configured to generate a package for the content manipulation device based on the content request, the package encrypted with the first secret key and including access rights specifying permitted manipulation of the digital content,
the input/output module configured to transmit the package to the content manipulation device over at least one communication device.

52. The authenticator of claim 51, wherein the processor verifies the content request by determining if the content manipulation device is authorized to access the digital content.

53. The authenticator of claim 51, wherein the processor generates a decline message if the content manipulation device is not authorized to access the digital content.

54. The authenticator of claim 51, wherein the input/output module receives user information from the content manipulation device over at least one communication link, the user information including identifying information of a user of the content manipulation device.

55-63. (canceled)
